(19) United States
(12) Patent Application Publication
(10) Pub. No.: US 2025/0293754 A1
(43) Pub. Date: Sep. 18, 2025

(54) SYSTEMS AND METHODS FOR FAST BEAM ACQUISITION

(71) Applicant: Huawei Technologies Co., Ltd., Shenzhen (CN)

(72) Inventors: Ahmad Abu Al Haija, Ottawa (CA); Mohammadhadi Baligh, Ottawa (CA); Xi Zhang, Beijing (CN)

(21) Appl. No.: 19/184,784

(22) Filed: Apr. 21, 2025

Related U.S. Application Data
(63) Continuation of application No. PCT/CN2022/128480, filed on Oct. 31, 2022.

(51) Int. Cl. H04B 7/06

(52) U.S. Cl. CPC H04B 7/06952

(57) ABSTRACT

Methods and devices are provided in which a synchronization signal block (SSB) pattern is transmitted on overlapping wide beams that include one or more auxiliary sequences that do not include physical broadcast channel (PBCH) payload. The auxiliary sequences may be transmitted on different time slots, for example different OFDM symbols, or different frequencies, or both. In some embodiments, for each SSB transmission, auxiliary sequences may be sent on a same frequency as the SSB, but different time slots or OFDM symbols. In some embodiments, the one or more auxiliary sequences are sent on the same time slot or OFDM symbol, but via a different radio frequency (RF) chain.

### CROSS REFERENCE

The present application is a continuation of International Application No. PCT/CN2022/128480, filed on Oct. 31, 2022, the disclosure of which is hereby incorporated by reference in its entirety.

### TECHNICAL FIELD

The present disclosure relates generally to wireless communications, and in particular to systems and methods for fast beam acquisition at sub-Terahertz (THz) band.

### BACKGROUND

In Fifth Generation (5G) New Radio (NR), a synchronization signal-physical broadcast channel (SS-PBCH) block (SSB) is transmitted with one antenna port, i.e. antenna port p=4000 is used for transmission of primary synchronization signal (PSS), secondary synchronization signal (SSS), physical broadcast channel (PBCH) and demodulation reference signal (DM-RS) for PBCH.

Recently, ultra-massive MIMO systems and sub-THz communication received heightened research interest as two of the key enablers for future wireless networks to meet the requirements of high data rate and bandwidth. While sub-THz band provides high bandwidth, ultra-massive MIMO systems help overcome the high path-loss in this band by providing high beamforming gain with narrow beams. Such narrow beams may need large overhead to be acquired even via beam sweeping.

While hierarchical beam sweeping may reduce overhead, several methods have been proposed to speed up beam acquisition. In these methods, a narrow beam is acquired directly from a wide beam instead of performing another stage of beam sweeping within the wide beams. These methods were inspired from mono-pulse radar techniques that help estimate the narrow beam from two or more wide beams through amplitude comparison (e.g. signal strengths) or phase comparison (via cross correlation or interferometer measurements), or both, between signals in the two or more beams.

Despite good performance and ability to speed up beam acquisition, deployment and utilization in the 5G standard have not received much attention including the impact of deployment and utilization in initial access procedures (e.g. SSB transmission and RACH procedure), non-initial access procedure, and/or other scenarios like reference signal (RS) configuration and measurements in downlink (DL) (RS like CSI-RS), uplink (UL) or sidelink (SL) (RS like S-RS). Hence, it may be of interest to investigate an impact of fast beam acquisition on these procedures.

### SUMMARY

According to some aspects of the present disclosure, there is provided an SSB pattern transmitted on overlapping wide beams that include one or more auxiliary sequences that do not include physical broadcast channel (PBCH) payload. The auxiliary sequences may be transmitted on different time slots, for example different OFDM symbols, or different frequencies, or both.

In some embodiments, the SSB pattern enables fast beam acquisition based on consideration of one or more of: beam steering delay at a base station or UE, or both, use of wide bandwidth at sub-THz frequency, and availability of one or more radio frequency (RF) chains at the base station or at the UE, or at both. In some embodiments, the patterns may be used as part of fast beam acquisition algorithms.

According to some aspects of the disclosure there is provided a method for beam acquisition involving for initial access process: receiving, by a user equipment (UE), one or more synchronization signal blocks (SSBs) and at least one auxiliary sequence, wherein the at least one auxiliary sequence is transmitted on a different but overlapped beam with that of the one or more SSBs; and transmitting, by the UE, feedback based on measurement of the one or more SSBs and the at least one auxiliary sequence. Such a method may have a benefit of reducing overhead for beam acquisition for use in, for example, but not limited to, an initial access process, and thereby increase speed of beam acquisition. Additional benefits may include improved usage of the wide bandwidth of sub-THz band or improved controllability of the adjacent beams within one SSB, or both. In some embodiments, a method using SSBs and at least one auxiliary sequence may be used in a random access channel process to gain benefits as described above.

In one implementation, before transmitting, the method may further comprise measuring, by the UE, the one or more SSBs and the at least one auxiliary sequence.

In some embodiments, the at least one auxiliary sequence is received on a same frequency as the one or more SSBs.

In some embodiments, the at least one auxiliary sequence is received on different orthogonal frequency division multiplexed (OFDM) symbols.

In some embodiments, the different OFDM symbols are spaced apart by at least one OFDM symbol.

In some embodiments, the at least one auxiliary sequence is received on a different frequency than the frequency that the one or more SSBs is received on.

In some embodiments, the at least one auxiliary sequence is at least two auxiliary sequences that are on frequencies that are different from one another and that are received on: a same OFDM symbol on the different frequencies; or different OFDM symbols on the different frequencies.

In some embodiments, transmitting the feedback involves transmitting a random access channel (RACH) preamble.

In some embodiments, the method further involves selecting, by the UE, the RACH preamble indicating a relation between signal strength of a signal component of the one or more SSBs and signal strength of each of the at least one auxiliary sequence.

In some embodiments, the at least one auxiliary sequence is at least two auxiliary sequences that are on frequencies that are different from one another and wherein the RACH preamble is selected from a group of RACH preambles, wherein the group includes one or more RACH preamble and the group indicates one of: the signal strength of the signal component is stronger than the signal strength of both the at least two auxiliary sequences; the signal strength of the signal component is weaker than the signal strength of both the at least two auxiliary sequences; the signal strength of the signal component is stronger than the signal strength of a first auxiliary sequence and weaker than the signal strength of a second auxiliary sequence; or the signal strength of the signal component is weaker than the signal strength of a first auxiliary sequence and stronger than the signal strength of a second auxiliary sequence.

In some embodiments, the signal component is one of a primary synchronization signal, a secondary synchronization signal, or channel state indication reference signal.

In some embodiments, the method further involves receiving, by the UE, a random access response using a beam selected based on the feedback.

In some embodiments, the method further involves transmitting, by the UE, a connection request and measurements of the signal component of the one or more SSBs and the signal strength of each of the at least one auxiliary sequence.

In some embodiments, the method further involves receiving, by the UE, configuration information indicating at least one of: the existence of the at least one auxiliary sequence; the respective frequencies the at least one auxiliary sequence is to be received on; or indices of OFDM symbols the at least one auxiliary sequence is to be received on.

In some embodiments, the configuration information is received in a master information block (MIB) or a system information block (SIB).

According to some aspects of the disclosure there is provided a device including a processor and a computer-readable storage medium. The computer-readable storage medium has stored thereon, computer executable instructions, that when executed by the processor, perform a method as described above or detailed below.

According to some aspects of the disclosure there is provided a method for beam acquisition involving: transmitting, by a base station, one or more SSBs and at least one auxiliary sequence, wherein the at least one auxiliary sequence is transmitted on a different but overlapped beam with that of the one or more SSBs; and receiving, by the base station, feedback based on measurement of the one or more SSBs and the at least one auxiliary sequence.

In some embodiments, the at least one auxiliary sequence is transmitted on a same frequency as the one or more SSBs.

In some embodiments, the at least one auxiliary sequence are transmitted on different OFDM symbols.

In some embodiments, the different OFDM symbols are spaced apart by at least one OFDM symbol.

In some embodiments, the one or more SSBs and the at least one auxiliary sequence is transmitted by a same radio frequency chain.

In some embodiments, the at least one auxiliary sequence is transmitted on a different frequency than the frequency that the one or more SSBs is transmitted on.

In some embodiments, the at least one auxiliary sequence is at least two auxiliary sequences that are on frequencies that are different from one another and that are transmitted on: a same OFDM symbol on the different frequencies; or different OFDM symbols on the different frequencies.

In some embodiments, the one or more SSBs and at least one of the at least two auxiliary sequences are transmitted by different radio frequency chains.

In some embodiments, receiving the feedback involves receiving a RACH preamble.

In some embodiments, the RACH preamble indicates a relation between signal strength of a signal component of the one or more SSBs and signal strength of each of the at least one auxiliary sequence.

In some embodiments, the at least one auxiliary sequence is at least two auxiliary sequences that are on frequencies that are different from one another and wherein the RACH preamble is an indication of one of: the signal strength of the signal component is stronger than the signal strength of both the at least two auxiliary sequences; the signal strength of the signal component is weaker than the signal strength of both the at least two auxiliary sequences; the signal strength of the signal component is stronger than the signal strength of a first auxiliary sequence and weaker than the signal strength of a second auxiliary sequence; or the signal strength of the signal component is weaker than the signal strength of a first auxiliary sequence and stronger than the signal strength of a second auxiliary sequence.

In some embodiments, the signal component is one of a primary synchronization signal, a secondary synchronization signal, or channel state indication reference signal.

In some embodiments, the method further involves transmitting, by the base station, a random access response using a beam having a beam width determined based on the feedback.

In some embodiments, the method further involves determining the beam width based on the feedback.

In some embodiments, the method further involves receiving, by the base station, a connection request and measurements of the signal component of the one or more SSBs and the signal strength of each of the at least one auxiliary sequence.

In some embodiments, the method further involves transmitting, by the base station, configuration information indicating at least one of: the existence of the at least one auxiliary sequence; the respective frequencies the at least one auxiliary sequence is to be received on; or indices of OFDM symbols the at least one auxiliary sequence is to be received on.

In some embodiments, the configuration information is transmitted in a MIB or a SIB.

According to some aspects of the disclosure there is provided a device including a processor and a computer-readable storage medium. The computer-readable storage medium has stored thereon, computer executable instructions, that when executed by the processor, perform a method as described above or detailed below.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1A is a schematic diagram of a communication system in which embodiments of the present disclosure may occur.

FIG. 1B is another schematic diagram of a communication system in which embodiments of the present disclosure may occur.

FIG. 2 is a block diagram illustrating units or modules in a device in which embodiments of the present disclosure may occur.

FIG. 3 is a block diagram illustrating units or modules in a device in which embodiments of the present disclosure may occur.

FIG. 4 is a schematic diagram illustrating SSB patterns for use with FR2-2 Bands.

FIG. 5A is a schematic diagram illustrating multiple antenna panels and resulting cross sections for beams used to send an SSB block, first auxiliary sequence (XSS1) and a second auxiliary sequence (XSS2) according to an aspect of the present disclosure.

FIG. 5B illustrates an example of beams that may be used for SSB and auxiliary sequences according to an aspect of the present disclosure.

FIG. 6 is a schematic diagram illustrating an SSB pattern that may be transmitted by a base station with multiple radio frequency chains (RFCs) according to an aspect of the present disclosure.

FIG. 7 is a schematic diagram illustrating an example of preamble grouping according to an aspect of the present disclosure.

FIG. 8 illustrates an example of a signal flow diagram for signaling used during a random access channel (RACH) procedure between a base station and UE in accordance with embodiments of the present disclosure.

FIG. 9A is a schematic diagram illustrating an example of coarse beam refinement according to an aspect of the present disclosure.

FIG. 9B is a schematic diagram illustrating an example of fine beam refinement according to an aspect of the present disclosure.

FIG. 10 illustrates an example of an SSB pattern that may be transmitted by a base station with a single RFC according to an aspect of the present disclosure.

FIG. 11 illustrates an example of a time and frequency resource on which an SSB block and auxiliary sequences are transmitted on beams in the azimuth and elevation directions according to an aspect of the present disclosure.

FIG. 12 illustrates an example of a signal flow diagram for signaling between a base station and UE in accordance with embodiments of the present disclosure.

### DETAILED DESCRIPTION

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

According to some aspects of the present disclosure, there is provided an SSB pattern transmitted on overlapping wide beams that include one or more auxiliary sequences that do not include physical broadcast channel (PBCH) payload. The auxiliary sequences may be transmitted on different time slots, for example different OFDM symbols, or different frequencies, or both.

In some embodiments, the SSB pattern enables fast beam acquisition based on consideration of one or more of: beam steering delay at a base station or UE, or both, use of wide bandwidth at sub-THz frequency, and availability of one or more radio frequency (RF) chains at the base station or at the UE, or at both. In some embodiments, the patterns may be used as part of fast beam acquisition algorithms.

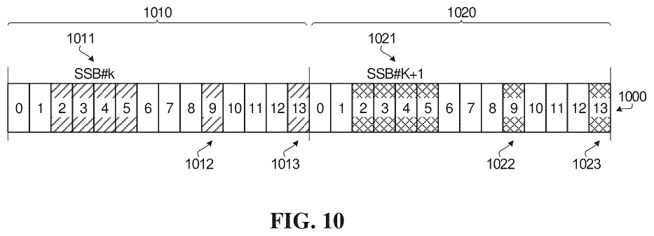

In some embodiments, for each SSB transmission, auxiliary sequences may be sent on a same frequency as the SSB, but different time slots or OFDM symbols. In some embodiments, a space is left between the SSB and one or more auxiliary sequences to allow updating the beam in which the one or more auxiliary sequences are sent. In some embodiments, the one or more auxiliary sequences are sent on the same time slot or OFDM symbol, but via a different RF chain, as will be discussed below with regard to the example shown in FIG. 10.

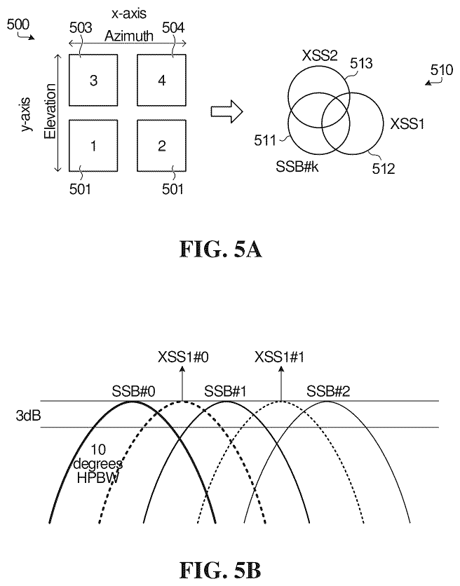

In some embodiments, the one or more auxiliary sequences may be sent on a different one or more frequencies (termed as complementary frequencies) than the frequency of the SSB. These embodiments will be discussed below with regard to the example shown in FIG. 6.

In some embodiments, for each SSB transmission, auxiliary sequences may be sent via the same beam direction of that for the SSB or via tilted beam direction with regard to the SSB.

In some embodiments, methods of signaling are provided for use during a random access channel (RACH) procedure and methods of using other higher layer signaling (like radio resource control (RRC) signaling) that benefit from additional measurements of one or more auxiliary sequence during SSB transmission.

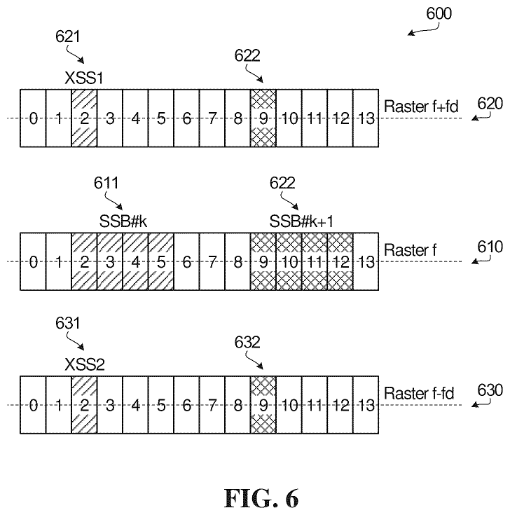

In some embodiments, methods of signaling may include sorting preambles or RACH occasions (i.e. RACH time and frequency resources), or both, into different subsets, where each subset pertains to measurement relations between the SSB and the one or more auxiliary sequences as will be discussed below with regard to the example shown in FIG. 7. Examples of measurement relations between the SSB and the one or more auxiliary sequences may include whether one or more of the measurements made by the UE, such as reference signal received power (RSRP), reference signal strength indication (RSSI), or signal-to-noise ratio (SNR) of a primary synchronization signal (PSS) or a secondary synchronization signal (SSS) in SSB, is greater or smaller than that of at least one of the one or more auxiliary sequences.

In some embodiments, methods of signaling may include transmission of Message1 (MSG1) and Message3 (MSG3) in a RACH process. In some embodiments, a MSG1 may include a preamble that belongs to one subset of the preambles. In some embodiments, a MSG1 is sent on a specific occasion that belongs to one subset of RACH occasions. Selection from a specific subset may provide implicit information that helps a base station coarsely refine a wide beam being used for transmission of the SSB. Such course refinement may be on the order of a factor of 2, and in some embodiments more or less than 2, in each of azimuth and elevation directions.

In some embodiments, a MSG3 (or later messages) may include measurements (e.g. signal strength measurements) of one or more of PSS, SSS, or auxiliary sequences. Such measurements may help the base station to acquire a narrow beam in the direction of the UE.

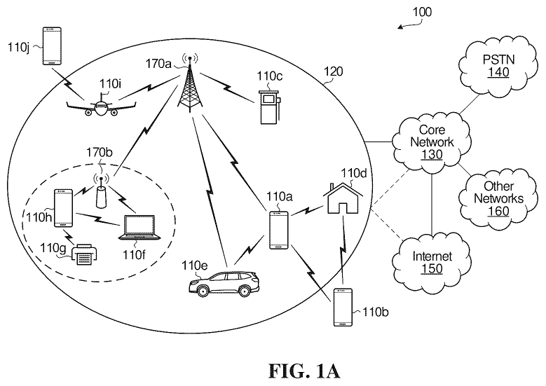

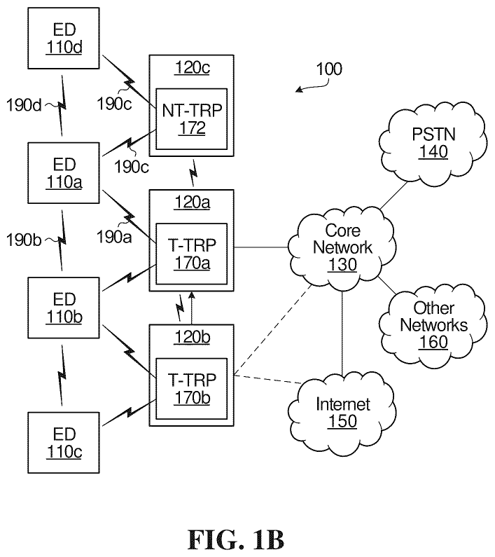

FIGS. 1A, 1B, and 2 following below provide context for the network and device that may be in the network and that may implement aspects of the present disclosure.

Referring to FIG. 1A, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

FIG. 1B illustrates an example communication system 100 in which embodiments of the present disclosure could be implemented. In general, the system 100 enables multiple wireless or wired elements to communicate data and other content. The purpose of the system 100 may be to provide content (voice, data, video, text) via broadcast, narrowcast, user device to user device, etc. The system 100 may operate efficiently by sharing resources such as bandwidth.

In this example, the communication system 100 includes electronic devices (ED) 110a-110c, radio access networks (RANs) 120a-120b, a core network 130, a public switched telephone network (PSTN) 140, the Internet 150, and other networks 160. While certain numbers of these components or elements are shown in FIG. 1B, any reasonable number of these components or elements may be included in the system 100.

The EDs 110a-110c are configured to operate, communicate, or both, in the system 100. For example, the EDs 110a-110c are configured to transmit, receive, or both via wireless communication channels. Each ED 110a-110c represents any suitable end user device for wireless operation and may include such devices (or may be referred to) as a user equipment/device (UE), wireless transmit/receive unit (WTRU), mobile station, mobile subscriber unit, cellular telephone, station (STA), machine type communication device (MTC), personal digital assistant (PDA), smartphone, laptop, computer, touchpad, wireless sensor, or consumer electronics device.

FIG. 1B illustrates an example communication system 100 in which embodiments of the present disclosure could be implemented. In general, the communication system 100 enables multiple wireless or wired elements to communicate data and other content. The purpose of the communication system 100 may be to provide content (voice, data, video, text) via broadcast, multicast, unicast, user device to user device, etc. The communication system 100 may operate by sharing resources such as bandwidth.

In this example, the communication system 100 includes electronic devices (ED) 110a-110d, radio access networks (RANs) 120a-120c, a core network 130, a public switched telephone network (PSTN) 140, the internet 150, and other networks 160. Although certain numbers of these components or elements are shown in FIG. 1B, any reasonable number of these components or elements may be included in the communication system 100.

The EDs 110a-110d are configured to operate, communicate, or both, in the communication system 100. For example, the EDs 110a-110d are configured to transmit, receive, or both, via wireless or wired communication channels. Each ED 110a-110d represents any suitable end user device for wireless operation and may include such devices (or may be referred to) as a user equipment/device (UE), wireless transmit/receive unit (WTRU), mobile station, fixed or mobile subscriber unit, cellular telephone, station (STA), machine type communication (MTC) device, personal digital assistant (PDA), smartphone, laptop, computer, tablet, wireless sensor, or consumer electronics device.

In FIG. 1B, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a transmission and receive point (TRP), a site controller, an access point (AP), or a wireless router.

In some examples, one or more of the base stations 170a-170b may be a terrestrial base station that is attached to the ground. For example, a terrestrial base station could be mounted on a building or tower. Alternatively, one or more of the base stations 172 may be a non-terrestrial base station, or non-terrestrial TRP (NT-TRP), that is not attached to the ground. A flying base station is an example of the non-terrestrial base station. A flying base station may be implemented using communication equipment supported or carried by a flying device. Non-limiting examples of flying devices include airborne platforms (such as a blimp or an airship, for example), balloons, quadcopters and other aerial vehicles. In some implementations, a flying base station may be supported or carried by an unmanned aerial system (UAS) or an unmanned aerial vehicle (UAV), such as a drone or a quadcopter. A flying base station may be a moveable or mobile base station that can be flexibly deployed in different locations to meet network demand. A satellite base station is another example of a non-terrestrial base station. A satellite base station may be implemented using communication equipment supported or carried by a satellite. A satellite base station may also be referred to as an orbiting base station.

Any ED 110a-110d may be alternatively or additionally configured to interface, access, or communicate with any other base station 170a-170b, the internet 150, the core network 130, the PSTN 140, the other networks 160, or any combination of the preceding.

The EDs 110a-110d and base stations 170a-170b, 172 are examples of communication equipment that can be configured to implement some or all of the operations and/or embodiments described herein. In the embodiment shown in FIG. 1B, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area.” A cell may be further divided into cell sectors, and a base station 170a-170b may, for example, employ multiple transceivers to provide service to multiple sectors. In some embodiments, there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b, 172 communicate with one or more of the EDs 110a-110c over one or more air interfaces 190a, 190c using wireless communication links e.g. radio frequency (RF), microwave, infrared (IR), etc. The air interfaces 190a, 190c may utilize any suitable radio access technology. For example, the communication system 100 may implement one or more orthogonal or non-orthogonal channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a, 190c.

A base station 170a-170b, 172 may implement Universal Mobile Telecommunication System (UMTS) Terrestrial Radio Access (UTRA) to establish an air interface 190a, 190c using wideband CDMA (WCDMA). In doing so, the base station 170a-170b. 172 may implement protocols such as High Speed Packet Access (HSPA), Evolved HPSA (HSPA+) optionally including High Speed Downlink Packet Access (HSDPA), High Speed Packet Uplink Access (HSPUA) or both. Alternatively, a base station 170a-170b, 172 may establish an air interface 190a,190c with Evolved UTMS Terrestrial Radio Access (E-UTRA) using LTE, LTE-A, and/or LTE-B. It is contemplated that the communication system 100 may use multiple channel access operation, including such schemes as described above. Other radio technologies for implementing air interfaces include IEEE 802.11, 802.15, 802.16, CDMA2000, CDMA2000 1×, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160).

The EDs 110a-110d communicate with one another over one or more sidelink (SL) air interfaces 190b, 190d using wireless communication links e.g. radio frequency (RF), microwave, infrared (IR), etc. The SL air interfaces 190b, 190d may utilize any suitable radio access technology, and may be substantially similar to the air interfaces 190a, 190c over which the EDs 110a-110c communication with one or more of the base stations 170a-170b, or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 190b, 190d. In some embodiments, the SL air interfaces 180 may be, at least in part, implemented over unlicensed spectrum.

In addition, some or all of the EDs 110a-110d may include operation for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP) and user datagram protocol (UDP). EDs 110a-110d may be multimode devices capable of operation according to multiple radio access technologies, and incorporate multiple transceivers necessary to support multiple radio access technologies.

In some embodiments, the signal is transmitted from a terrestrial BS to the UE or transmitted from the UE directly to the terrestrial BS and in both cases the signal is not reflected by a RIS. However, the signal may be reflected by the obstacles and reflectors such as buildings, walls and furniture. In some embodiments, the signal is communicated between the UE and a non-terrestrial BS such as a satellite, a drone and a high altitude platform. In some embodiments, the signal is communicated between a relay and a UE or a relay and a BS or between two relays. In some embodiments, the signal is transmitted between two UEs. In some embodiments, one or multiple RIS are utilized to reflect the signal from a transmitter and a receiver, where any of the transmitter and receiver includes UEs, terrestrial or non-terrestrial BS, and relays.

FIG. 2 illustrates another example of an ED 110 and network devices, including a base station 170a, 170b (at 170) and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 2, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1A or 1B). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the forging devices, or to apparatus (e.g. communication module, modem, or chip) in the forgoing devices. While the figures and accompanying description of example and embodiments of the disclosure generally use the terms AP, BS, and AP or BS, it is to be understood that such device could be any of the types described above.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 2. FIG. 2 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

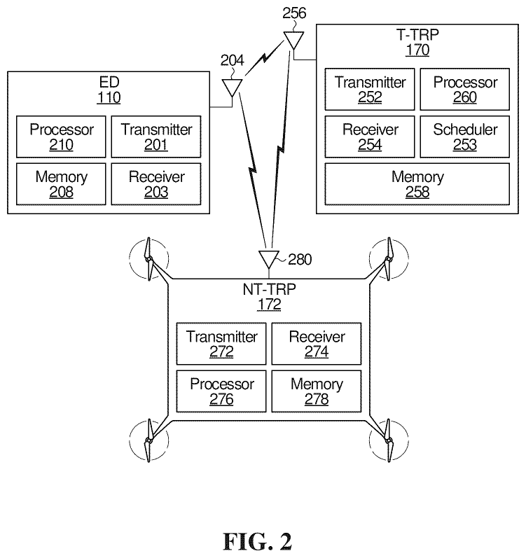

One or more steps of the embodiment methods provided herein may be performed by corresponding units or modules, according to FIG. 3. FIG. 3 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

For future wireless networks, a number of the new devices could increase exponentially with diverse functionalities. Also, many new applications and new use cases in future wireless networks than existing in 5G may emerge with more diverse quality of service demands. These will result in new key performance indications (KPIs) for the future wireless network (for an example, 6G network) that can be extremely challenging, so the sensing technologies, and AI technologies, especially ML (deep learning) technologies, had been introduced to telecommunication for improving the system performance and efficiency.

AI/ML technologies applied communication including AI/ML communication in Physical layer and AI/ML communication in media access control (MAC) layer. For physical layer, the AI/ML communication may be useful to optimize the components design and improve the algorithm performance, like AI/ML on channel coding, channel modelling, channel estimation, channel decoding, modulation, demodulation, MIMO, waveform, multiple access, PHY element parameter optimization and update, beam forming & tracking and sensing & positioning, etc. For MAC layer, AI/ML communication may utilize the AI/ML capability with learning, prediction and make decisions to solve the complicated optimization problems with better strategy and optimal solution, for example to optimize the functionality in MAC, e.g. intelligent TRP management, intelligent beam management, intelligent channel resource allocation, intelligent power control, intelligent spectrum utilization, intelligent modulation and coding scheme (MCS), intelligent hybrid automatic repeat request (HARQ) strategy, intelligent transmit/receive (Tx/Rx) mode adaption, etc.

AI/ML architectures usually involve multiple nodes, which can be organized in two modes, i.e., centralized and distributed, both of which can be deployed in access network, core network, or an edge computing system or third-party network. The centralized training and computing architecture is restricted by huge communication overhead and strict user data privacy. Distributed training and computing architecture comprise several frameworks, e.g., distributed machine learning and federated learning. AI/ML architectures comprises intelligent controller which can perform as single agent or multi-agent, based on joint optimization or individual optimization. A new protocol and signaling mechanism is needed so that the corresponding interface link can be personalized with customized parameters to meet particular requirements while minimizing signaling overhead and maximizing the whole system spectrum efficiency by personalized AI technologies.

Further terrestrial and non-terrestrial networks can enable a new range of services and applications such as earth monitoring, remote sensing, passive sensing and positioning, navigation, and tracking, autonomous delivery and mobility. Terrestrial networks based sensing and non-terrestrial networks based sensing could provide intelligent context-aware networks to enhance the UE experience. For example, terrestrial networks based sensing and non-terrestrial networks based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial and non-terrestrial networks, the measured channel data and sensing and positioning data can be obtained by the large bandwidth, new spectrum, dense network and more light-of-sight (LOS) links. Based on these data, a radio environmental map can be drawn through AI/ML methods, where channel information is linked to its corresponding positioning or environmental information to provide an enhanced physical layer design based on this map.

Sensing coordinators are nodes in a network that can assist in the sensing operation. These nodes can be standalone nodes dedicated to just sensing operations or other nodes (for example TRP 170, ED 110, or core network node) doing the sensing operations in parallel with communication transmissions. A new protocol and signaling mechanism is needed so that the corresponding interface link can be performed with customized parameters to meet particular requirements while minimizing signaling overhead and maximizing the whole system spectrum efficiency.

AI/ML and sensing methods are data-hungry. In order to involve AI/ML and sensing in wireless communications, more and more data are needed to be collected, stored, and exchanged. The characteristics of wireless data expand quite large ranges in multiple dimensions, e.g., from sub-6 GHz, millimeter to Terahertz carrier frequency, from space, outdoor to indoor scenario, and from text, voice to video. These data collecting, processing and usage operations are performed in a unified framework or a different framework.

Control information is referenced in some embodiments herein. Control information may sometimes instead be referred to as control signaling, or signaling. In some cases, control information may be dynamically communicated, e.g. in the physical layer in a control channel, such as in a physical uplink control channel (PUCCH) or physical uplink shared channel (PUSCH) or physical downlink control channel (PDCCH). An example of control information that is dynamically indicated is information sent in physical layer control signaling, e.g. uplink control information (UCI) sent in a PUCCH or PUSCH or downlink control information (DCI) sent in a PDCCH. A dynamic indication may be an indication in a lower layer, e.g. physical layer/layer 1 signaling, rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling (such as RRC signaling), and/or a MAC CE. Dynamic signaling, as used herein, may refer to signaling that is dynamic, e.g. physical layer control signaling sent in the physical layer, such as DCI sent in a PDCCH or UCI sent in a PUCCH or PUSCH.

Generally, the 5th Generation (5G) telecommunication standard provides a general synchronization signal block (SSB) pattern without mandating any specific beam acquisition algorithm. SSB pattern refers to the time and frequency resource (for example one or more time indices and one or more raster frequency) for different SSB blocks in an SSB burst, where the SSB includes PSS, SSS, and PBCH.

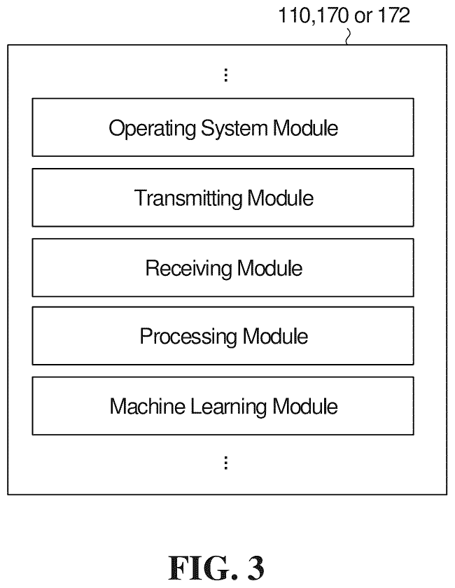

An example of an SSB pattern at frequency range 2 (FR2-2) frequency range (52.6-71 GHz) is shown in FIG. 4 where sub-carrier spacing (SCS) of 120 kHz, 480 kHz, and 960 kHz are supported. The SSB pattern for SCS of 120 kHz 400 is shown to include two consecutive SSBs 410, 420 occurring over each set of 14 OFDM symbols. In a first set of 14 OFDM symbols 410, a first SSB 412 is shown to occur from OFDM symbol 4 to OFDM symbol 7. A second SSB 414 is shown to occur from OFDM symbol 8 to OFDM symbol 11. The SSB pattern for SCS of 480 kHz/960 kHz 450 is shown to include two SSBs 462, 464 occurring over each set of 14 OFDM symbols 460, 470. In a first set of 14 OFDM symbols 460, a first SSB 462 is shown to occur from OFDM symbol 2 to OFDM symbol 5. A second SSB 464 is shown to occur from OFDM symbol 9 to OFDM symbol 12. For 480 kHz and 960 kHz, the OFDM symbol duration becomes shorter (compared to 120 kHz and smaller SCS) and there are three OFDM symbols 463 left between two consecutive SSB blocks 462, 464. These OFDM symbols 463 may help the base station steer a base station beam in another direction between two SSB blocks 462,464.

The cardinality, which is the number of SSB blocks, of the SSB burst that is supported, is up to 64 SSB blocks. Based on an example cardinality of 64 and in order to cover a range of 120 degrees in azimuth direction (e.g. 120 degrees corresponds to one sector in a communication cell) and 90 degrees in elevation direction, a width of the beams that are used to send each of the 64 SSB blocks may be approximately 13 degrees in each direction, azimuth and elevation. Therefore, in order to acquire a narrow beam, which may be considered to be 2 degrees of beam width, the usage of fast beam acquisition becomes highly important.

There are several scenarios in which embodiments of the present disclosure may be used. One scenario is an Initial Access (IA) method, which may include SSB transmission and a RACH procedure. Another scenario may be a non-initial access method where sending one or more auxiliary sequences may be deployed in association with reference signals that are transmitted for DL (e.g. CSI-RS), UL, or SL (e.g. S-RS). A further scenario may include beam tracking when also considering UE motion. For example, while two devices are sharing a link using wide beams, frequent acquisitions of a narrow beam may help track UE angular movement. Angular movement pertains to the scenario when the UE or object being tracked movement is perpendicular to a straight line between the transmitter and the UE or object being tracked. Radial movement pertains to the scenario when the UE or object being tracked movement is in the same direction of a straight line between the transmitter and the UE or object being tracked.

Some aspects of the disclosure may be applicable when a base station is transmitting an SSB burst to be used for downlink synchronization at a UE. Beam sweeping may be carried out by either or both of the base station and the UE. In some embodiments, the base station may be equipped with more than one radio frequency chain (RFC) where each RFC may send different information and may be connected to a different antenna panel or array.

In the case of a DL scenario where a base station is transmitting to a UE, the base station transmits an SSB transmission (i.e. SSB in LTE and NR that consists of PSS, SSS and PBCH). In some embodiments, the base station also transmits one or more auxiliary sequences (XSS) to help estimate a narrow beam in at least one of an azimuth direction and an elevation direction. An auxiliary sequence refers to a sequence (such as a synchronization signal or more generally a reference signal) that is sent in addition to a second reference signal (such as PSS, SSS, S-RS, or CSI-RS) but sent via a tilted beam or on the same beam direction compared to that of the second reference signal. The purpose of the auxiliary sequences is to help improve measurement results, which may increase the speed of the beam acquisition process.

In a particular example, the base station may transmit two auxiliary sequences, a first auxiliary sequence (XSS1) and a second auxiliary sequence (XSS2). XSS1 may be used to help estimate the beam in the azimuth direction and XSS2 may be used to help estimate the beam in the elevation direction. However, it is to be understood that XSS1 may be used to help estimate the beam in the elevation direction and XSS2 may be used to help estimate the beam in the azimuth direction. Furthermore, other directional systems may be used as opposed to azimuth and elevation directions. Also, a single auxiliary sequence or more than two auxiliary sequences may be transmitted.

A cell-defining SSB (CD-SSB) refers to SSB that has an associated SIB1 transmission while non-CD-SSB refers to the SSB that does not have an associated SIB1 transmission.

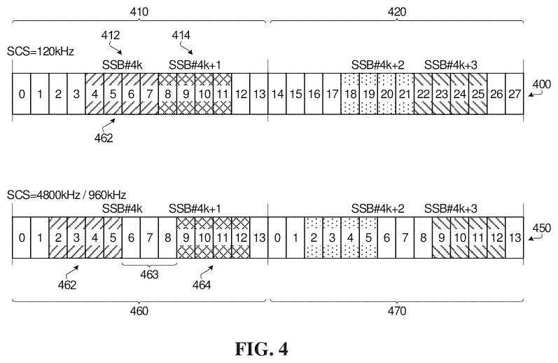

FIG. 5A illustrates an example of how multiple antenna panels, each connected to a separate RFC, may be used to transmit SSB, XSS1, and XSS2. FIG. 5A illustrates a particular example in which a set 500 of four antenna panels 501, 502, 503, 504 are arranged in a 2×2 array in terms of directionality, in which the x-axis corresponds to the azimuth direction and the y-axis corresponds to the elevation direction. In FIG. 5A, SSB, XSS1, and XSS2 are transmitted on three of the four antennas. The SSB is transmitted on a first antenna panel 501, XSS1 is transmitted on a second antenna panel 502, and XSS2 is transmitted on a third antenna panel 503. Also shown in FIG. 5A are representations of cross sections 510 of beams that correspond to three of the four antenna panels. These cross sections are representative of being on a spherical surface centered at the transmitter at a radius of a few times larger than the Rayleigh distance, for example. In antenna applications, the Rayleigh distance is the distance that separates near field from far field is defined by

$$\frac{2 {L}^{2}}{λ} ,$$

where L is the maximum linear dimension of the antenna array, which is defined as a maximum distance of a straight line between any two point of the subarray or panel (e.g. length of a linear array, diagonal of a rectangular array and diameter of a circular array. Moreover, λ is a wavelength defined as c/f where c is the speed of light and f is the frequency that belongs to the operational frequency range of the antenna array or panel, which is the range of frequencies over which the antenna array or panel operates with acceptable gain (achieves certain threshold).

Cross section 511 corresponds to the first antenna panel 501 for transmitting SSB, cross section 512 corresponds to the second antenna panel 502 for transmitting XSS1 and cross section 513 corresponds to the third antenna panel 503 for transmitting XSS2.

It is to be understood that the antenna panels used in FIG. 5A is merely one example and not intended to limit the scope of the disclosure. In some embodiments, only one XSS is transmitted on a single antenna panel other than the antenna panel transmitting the SSB. In some embodiments, more than the two XSS described with relation to FIG. 5A may be transmitted on a corresponding number of antenna panels. Other arrangements with regard to the particular 2×2 antenna panel arrangement may include XSS1 and XSS2 being transmitted on antenna panels 2 and 4, respectively, or on antenna panels 3 and 4 respectively. Furthermore, the SSB may be transmitted on any of antenna panels 2, 3, and 4, and one or more XSS may be transmitted one any antenna panels not being used for transmitting the SSB. In addition, while a 2×2 arrangement of antenna panels is shown in FIG. 5A, other arrangements of antenna panels connected to separate RFC are also considered.

FIG. 5B is an example of a portion of an azimuth angular domain that includes three SSBs (SSB #0, SSB #1 and SSB #2) occupying respective beam-widths. Also shown are two XSSs for the azimuth direction, associated with SSB #1, occupying respective beam-widths. A first XSS (XSS1 #0) is located between SSB #0 and SSB #1 and a second XSS (XSS1 #1) is located between SSB #1 and SSB #2. The 3 dB beam-width allows a 10 degree half power beam-width (HPBW). While FIG. 5B shows two auxiliary sequences for the azimuth direction, it is to be understood that there may be a single auxiliary sequence in a given direction or more than two auxiliary sequences in a given direction.

FIG. 6 illustrates an example of an SSB pattern 600 where each of the SSB payload, XSS1 and XSS2, is sent via a different RFC. FIG. 6 illustrates three sets of 14 OFDM symbols 610, 620, and 630. The SSB pattern 600 includes two consecutive SSBs (SSB #k 611 and SSB #k+1 612, where k is an integer value) occurring over the first set of 14 OFDM symbols 610. The first set of 14 OFDM symbols 610 is transmitted on a first frequency f, which is referred to as a raster frequency. XSS1 includes two consecutive XSS1s (XSS1 #k 621 and XSS1 #k+1 622) occurring over a second set of 14 OFDM symbols 620. The second set of 14 OFDM symbols 620 is transmitted on a second frequency f+fd, which is offset from the raster frequency by a frequency fd. XSS2 includes two consecutive XSS2s (XSS2 #k 631 and XSS2 #k+1 632) occurring over a third set of 14 OFDM symbols 630. The third set of 14 OFDM symbols 630 is transmitted on a third frequency f-fd, which is offset from the raster frequency by a frequency fd, but a different frequency than the frequency on which XSS1 is transmitted. The second and third frequencies offset from the raster frequency may be referred to as complementary frequencies. It should be noted that the raster and complementary frequencies are reasonably close to each other so that the propagation channel is considered to be consistent over the raster and complementary frequencies (e.g. fd≤0.01 of f).

While the SSB, XSS1 and XX2 are shown to occupy particular OFDM symbols, it is to be understood that this is not intended to limit embodiments to only this pictured example. Also, while the pattern is shown to be occurring within a set of 14 OFDM symbols, other embodiments may occur in a larger or smaller sized group of OFDM symbols, or alternative slot size. It should be also noted that it is possible to send more than two sequences (e.g. the auxiliary sequences (e.g. XSS1 or XSS2) or the PSS in SSB) on the same frequency and time (e.g. OFDM symbols) via different RFCs. However, such sequences may be orthogonal to aid in mitigating potential interference.

In some embodiments, the use of the auxiliary sequences and values of the frequencies that the auxiliary frequencies are being transmitted on may be standardized and may be provided to the UE. In some embodiments, the use of the auxiliary sequences and values of the frequencies that the auxiliary sequences are being transmitted on may be included in a physical broadcast channel (PBCH) payload, such as master information block (MIB1), or in system information block (SIB1).

In some embodiments, the auxiliary sequences on the corresponding frequencies may be sent on the same OFDM symbols (for example OFDM symbols 2 and 9 in the second and third sets of 14 OFDM symbols 620, 630, respectively as shown in FIG. 6). In some embodiments, the auxiliary sequences on the corresponding frequencies may be sent on different OFDM symbols (for example OFDM symbols 2 and 9 in the second set of 14 OFDM symbols 620 and OFDM symbols 3 and 10 in the third set of 14 OFDM symbols 630). In some embodiments, the OFDM symbol location for the auxiliary sequences may be standardized and may be provided to the UE. In some embodiments, the OFDM symbol location for the auxiliary sequences may be included in a PBCH payload, such as MIB1, or in SIB1.

During any of IA and SSB transmission and RACH methods, aspect of the present disclosure may be used in which the UE may perform one or more of the following measurements and transmissions.

In some embodiments, when the UE is performing SSB measurements, the UE may use autocorrelation when measuring the SNR, RSRP or RSSI of the PSS or SSS at the raster frequency. For the SSB when the PSS or SSS, or both, are received with SNR or RSSI that achieves or exceeds a certain threshold, the UE may perform similar autocorrelation measurements of one or more XSS at complementary frequencies. It is to be understood that other methods of measurement maybe used, such as, but not limited to, cross correlation. It should be noted that in some embodiments the UE may receive one SSB via more than one path (e.g. LOS and one reflected path). The UE may distinguish between different paths via temporal resolution and different propagation lengths of the multiple paths. For example, with 1 GHz bandwidth of the pilot signal (such as PSS, SSS, or XSS), the temporal resolution is on the order of 1 ns (nano seconds), which is equivalent to approximately 30 cm of electromagnetic wave travel distance. As such the UE may distinguish between the two paths if the difference between the distances of the two paths is at least about 30 cm. Then, for each path, the UE may perform the same measurements stated above including one or more of SNR, RSRP or RSSI for one or more of the PSS, SSS, and XSS at the raster or complementary frequencies.

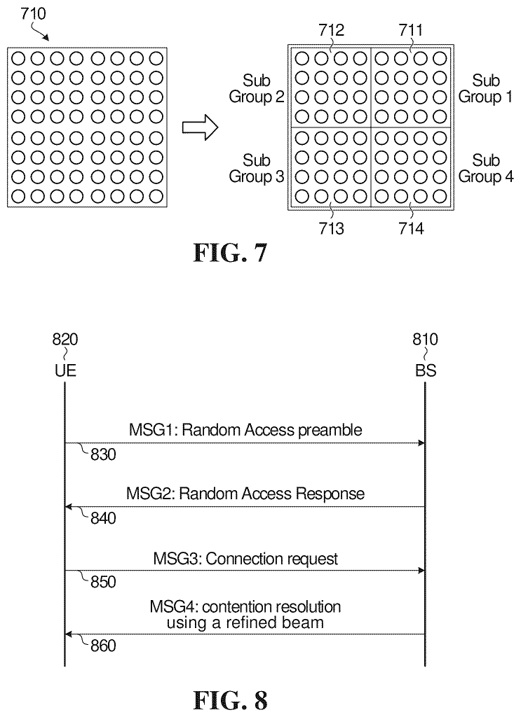

FIG. 8 illustrates an example of a four step RACH method between a base station (BS) 810 and a UE 820 in which embodiments of the present disclosure may be used. At step 830, the UE 820 sends a random access (RA) preamble to the base station 810. As will be described in further detail below, the UE 820 may select a particular preamble that indirectly indicates a relationship between measured signal strength of the SSB and the one or more auxiliary sequences. At step 840, the base station 810 sends a random access response (RAR) using a beam that has been refined based on the indirect information included in the preamble received by the base station 810 in step 830. At step 850, the UE 820 sends a connection request to the base station 810 that includes measurements of the SSB and the at least one auxiliary sequence that were made prior to step 830. At step 860, the base station 810 sends contention resolution using a narrow beam that has been refined based on the measurement information included in the connection request by the base station 810 in step 850. It should be further noted that preamble or RACH occasion grouping may not be performed in all embodiments. For example, the UE 820 may select a preamble from the entirety of the preamble set and send the selected preamble at step 830 on a RACH occasion that is associated with the beam of the SSB that is received with good signal strength (i.e. the signal strength satisfies a minimum threshold). Then, the base station 810 sends RAR at step 840 in a direction of the same beam of the SSB without refinement. After that, at step 850, the UE 820 sends a connection request to the base station 810 that includes measurements of the SSB and the at least one auxiliary sequence. At step 860, the base station 810 sends contention resolution using a narrow beam that has been refined based on the measurement information included in the connection request by the base station 810 in step 850.

When performing a RACH procedure as described above, the UE may select a preamble from a specific group that indicates a relation between signal strength of the PSS or SSS and one or more of the auxiliary sequences (for example when two auxiliary sequences are being used, XSS1 and XSS2). When the UE receives the SSB via more than one path, the UE may select the preamble from a specific group that indicates a relation between signal strength of the PSS or SSS and one or more of the auxiliary sequences for one of the paths (e.g. the path where the PSS is received with the strongest signal strength compared to other paths). In some embodiments, the preamble grouping may be standardized and may be provided to the UE (e.g. the preamble grouping may be sent to the UE via higher layer signaling such as RRC signaling). In a particular example, when using two auxiliary sequences, one for elevation direction and one for azimuth direction, the preamble set may be divided into four groups. FIG. 7 shows an example of a preamble set 710 that includes 64 possible preambles that the UE could select from. The 64 preambles are also shown subdivided into four subgroups of 16 preambles each, subgroup 1 711, subgroup 2 712, subgroup 3 713, and subgroup 4 714. Each of the four subgroups represents a different association between measurement of received SSB and received auxiliary sequences XSS1 and XSS2. For example, selection of a preamble from subgroup 1 711 implies that the received signal of PSS (or SSS) in the SSB is stronger than both XSS1 and XSS2 received signals. Selection of a preamble from subgroup 2 712 implies that the received signal of PSS (or SSS) is weaker than both XSS1 and XSS2. Selection of a preamble from subgroup 3 713 implies that the received signal of PSS (or SSS) is stronger than XSS1 received signal and weaker than XSS2 received signal. Selection of a preamble from subgroup 4 714 implies that the received signal of PSS (or SSS) is weaker than XSS1 received signal and stronger than XSS2 received signal.

FIG. 7 illustrates a particular partitioning for particular relationships between measured signal strengths of SSB and auxiliary sequences for a particular number of preambles. It is to be understood that this is not intended to limited the scope of the disclosure. The basic principle may be applied to groups of preambles larger or smaller than 64 as shown in FIG. 7. Also, the arrangement of the subgroups and the number of subgroups may be different than that shown in FIG. 7.

Still with reference to the preamble set of FIG. 7, the UE sends a preamble selected from the group of 64 preambles to the base station. In some embodiments, the selected preamble may be sent via MSG1 as shown in step 820 of FIG. 8. The base station detects the preamble and based on the subgroup the preamble was selected from by the UE, the base station will know the relation between the received signal strength of PSS (or SSS) of the SSB and that of XSS1 and XSS2. In some embodiments, the knowledge of this relationship may help the base station coarsely estimate a beam width with which to send a message2 (MSG2) at step 840 in FIG. 8. Coarse beam width estimation here determines a beam width that is narrower than the beam width that is used to send SSB, XSS1 and XSS2, but still wider than a beam width that may eventually be determined for signaling between the base station and UE based on the actual measurements of the strength of one or more of the received PSS or SSS of the SSB, XSS1, and XSS2.

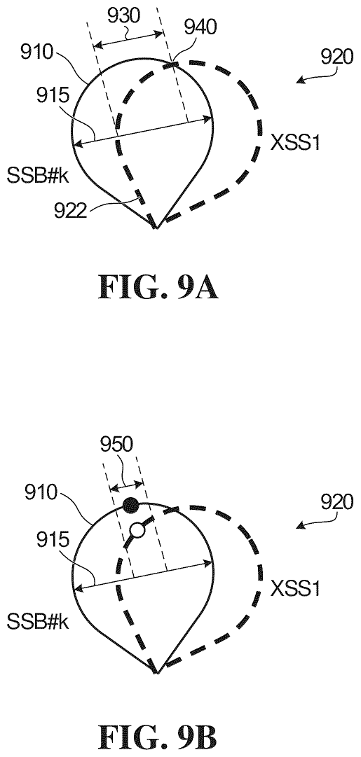

FIG. 9A illustrates an example of coarse beam width refinement that may be determined by a base station prior to sending a MSG2 at step 840 based on a preamble indicating that the SNR of the PSS is larger than the SNR of XSS1. FIG. 9A shows a first beam 910 used for transmission of SSB #k (where k is an integer) and a second beam 920 used for transmission of XSS1. In FIG. 9A, both the first beam 910 and the second beam 920 have a similar sized beam width 915, but this is not necessarily always the case. A narrower beam width 930 may be determined having a beam width that is based on a leading edge 922 of the second beam 920 and a cross over point 940 of the first and second beams 910 and 920.

Actual measurements of the received signals PSS, SSS, XSS1, and XSS2 for one or more paths may be sent by the UE in MSG3, such as step 850 in FIG. 8, or subsequent signaling. This may allow the base station to perform further beam width refinement for a beam and use the further refined beam to transmit MSG4 and other data to the UE. FIG. 9B illustrates an example of further beam refinement based on knowledge of measured values of the SNR of the PSS and the SNR of XSS1. FIG. 9B shows the first beam 910 and the second beam 920. A narrower beam width 950 may be determined by the base station for use in transmitting MSG 4 as in step 860 in FIG. 8, than the beam width 930 in FIG. 9A based on the measurements made by the UE and provided to the base station by the MSG3 in step 850 of FIG. 8.

The following is an example pertaining to particular beam widths and referring to FIGS. 9A and 9B. Assuming that SSB #k and XSS1 intersect as shown at 640 in FIG. 9A in a direction denoted as 0 degrees (i.e. angle of departure (AoD) is 0 degrees). SSB #k is sent on a beam at −5 degrees, AoD=−5 degrees, which is to the left of the intersection of beams at 0 degrees. The gain (and hence the SNR) for receiving SSB #K is the highest at −5 degrees. XSS1 is sent on a beam at +5 degrees (AoD=+5 degrees which is to the right of the intersection of beams at 0 degrees. The beam width of each of SSB #k and XSS1 is 20 degrees, i.e. SSB #k HPBW is between −15 degrees and +5 degrees and XSS1 HPBW is between −5 degrees and +15 degrees.

In FIG. 9A, by knowing that the SNR (of SSB #k)>SNR (of XSS1), it is possible to determine that the AoD is between −5 and 0 degrees. Hence, the base station may send MSG2 in the AoD=−2.5 degrees with HPBW of 5 degrees.

Then, by sending the actual values of the SNRs (of SSB #k and XSS1) in MSG3, the base station can estimate that AoD=−3 degrees, while the beamwidth is determined based on the mean square error (MSE) performance (e.g. −3 degrees is estimated with accuracy of +1 degree and −1 degrees). Hence, the refined beam is designed at −3 degrees of AoD with a beamwidth of 2 degrees.

In some embodiments, the SSB pattern, including transmission of auxiliary signals, may be transmitted when the base station uses one or more antenna panels, but the antenna panels are connected to only a single RFC.

In another DL scenario, where a base station is transmitting to a UE, the base station transmits the SSB transmission (i.e. SSB in LTE and NR that consists of PSS, SSS and PBCH) and also transmits one or more auxiliary sequences to help estimate the narrow beam in at least one of azimuth direction and elevation direction.

In a particular example, the base station may transmit two auxiliary sequences, a first auxiliary sequence (XSS1) and a second auxiliary sequence (XSS2). In some embodiments, XSS1 may be used to help estimate the beam in the azimuth direction and XSS2 may be used to help estimate the beam in the elevation direction. In some embodiments, XSS1 and XSS2 are sent on the same raster frequency, but different OFDM symbols.

FIG. 10 illustrates an example of an SSB pattern 1000 in which the SSB payload and the auxiliary sequences, i.e. XSS1 and XSS2, are all sent via the same RFC. FIG. 10 illustrates two sets 1010 and 1020 of 14 OFDM symbols on a single raster frequency. The SSB pattern 1000 includes one SSBs (SSB #k 1011 and SSB #k+1 1021) occurring over the first and second sets of 14 OFDM symbols 1010, 1020, respectively. XSS1 includes one auxiliary sequence (XSS1 #k 1012 and XSS1 #k+1 1022) occurring over each set of 14 OFDM symbols (1010 and 1020). XSS2 includes one auxiliary (XSS2 #k 1013 and XSS2 #k+1 1023) occurring over each set of 14 OFDM symbols (1010 and 1020). In some embodiments, an indication that the auxiliary sequences are being used and the value of the raster frequency that the SSBs and auxiliary sequences are being transmitted on may be standardized and may be provided to the UE. In some embodiments, the use of the auxiliary sequences and values of the frequencies that are being transmitted on may be included in a PBCH payload, such as MIB1, or in SIB1.

Since the auxiliary sequences are sent on tilted beams (compared to that of the SSB) or on the same beam direction but with some modification to phase components of the transmission, beam steering (and/or phase shifts that are changed at different antennas) may add delay. Hence, one or more OFDM symbols may be left between the SSB and XSS1 (OFDM symbols 6 to 8) and between XSS1 and XSS2 (OFDM symbols 10 to 12) as shown in FIG. 10 to enable the beam steering or phase shift to be configured before subsequent transmission.

In some embodiments, the SSB patterns shown in FIGS. 6 and 10 may be used in conjunction when the base station has more than one RF chain. For example, XSS1 may be sent on the same raster frequency for PSS, SSS and PBCH, but a different OFDM symbol, while XSS2 is sent on a complementary frequency as shown in FIG. 6 via a different RFC.

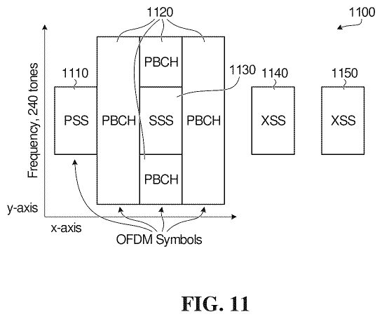

FIG. 11 illustrates an example of a time and frequency resource 1100 that may be used for transmission of PSS, SSS, PBCH and auxiliary sequences. The x-axis corresponds to the time domain and individual columns are representative of OFDM symbols. More generally the columns in FIG. 11 may correspond to a desired size of time slot. The y-axis corresponds to the frequency domain and is representative of at least a portion of frequency tones making up a bandwidth being used for communication. A portion 1110 of a first OFDM symbol is used for transmission of the PSS. Portions 1120 of a second, a third and a fourth OFDM symbol are used for transmission of the PBCH. A portion 1130 of the third OFDM symbol is used for transmission of the SSS. Nothing is shown in a fifth symbol and a seventh ODFM symbol. A portion 1140 of a sixth OFDM symbol is used for transmission of a first auxiliary sequence (XSS). The first XSS may be transmitted with a tilted beam for the azimuth direction. A portion 1150 of an eighth OFDM symbol is used for transmission of a second XSS. The second XSS may be transmitted with a tilted beam for the elevation direction.

While the SSB, XSS1 and XX2 are shown to occupy particular OFDM symbols in FIG. 11, it is to be understood that this is not intended to limit embodiments to only this pictured example. Also, while the pattern is shown to be occurring within a set of 14 OFDM symbols, other embodiments may occur in a larger or smaller sized group of OFDM symbols, or alternative slot size.

During any of IA and SSB transmission and RACH procedure, the UE may perform one or more of the following measurements and transmissions.

In some embodiments, when the UE is performing SSB measurements, the UE may use autocorrelation when measuring the SNR, RSRP or RSSI (and possibly the phase) of the PSS or SSS at the raster frequency. For the SSB where the PSS and SSS are received with SNR or RSSI that achieves or exceeds a certain threshold, the UE may perform similar autocorrelation measurements of one or more XSS at complementary frequencies. It is to be understood that other methods of measurement maybe used, such as, but not limited to, cross correlation. It should also be noted that in some embodiments, the UE may receive one SSB via more than one path (e.g. LOS and one reflected path). The UE may distinguish between different paths via temporal resolution and different propagation lengths of the multiple paths. For example, with 1 GHz bandwidth of the pilot signal (such as PSS, SSS, or XSS), the temporal resolution is on the order of 1 ns (nano seconds), which is equivalent to approximately 30 cm of electromagnetic wave travel distance. As such the UE may distinguish between the two paths if the difference between the distances of the two paths is at least 30 cm. Then, for each path, the UE may perform the same measurements stated above including one or more of SNR, RSRP or RSSI for one or more of the PSS, SSS, and XSS.

When the SSB and one or more auxiliary sequences are transmitted using a single RFC, the RACH procedure may be similar to that shown in FIG. 8 including the use of preamble grouping, transmission of the selected preamble for MSG1 (that helps the base station for coarse beam refinement) and transmission of the measurements in MSG3 or later signaling (that helps the base station in determining fine beam refinement).

It should be also noted that the beams for SSB and auxiliary sequences can be in the same direction. In such a scenario, the phases of the antennas (when connected to the same RFC) may be different in different time slots or OFDM symbols. For example, with reference to the antenna panel arrangement shown in FIG. 5A (but having different RFC connection than described above), a base station may have two panels (panel 1 and panel 2) connected to one RFC that are arranged in an azimuth direction. Similarly, two panels (panel 1 and panel 3) are connected to one RFC that are arranged in an elevation direction. The SSB is sent from each set of the two panels arranged in the same direction, with a same phase shift applied to antennas of each of the sets of the two panels. Three XSSs (XSS1, XSS2, XSS3) may be sent on three OFDM symbols, in the same beam directions (to SSB) from each of sets of the two panels. However, the phase shifts applied for the antennas in panel 1 are the same over the three OFDM symbols and SSB transmission, while the phase shifts for the antennas of panel 2 are similar to those used for SSB, but after adding π/2, π, 3π/2 phases when sending XSS1, XSS2, XSS3, respectively. The UE measures the received signal strengths of the PSS or SSS in SSB, XSS1, XSS2, and XSS3, which are denoted as ρ0, ρ1, ρ2, and ρ3, respectively. Such measurements pertain to the phase difference of the signals from panel 1 and panel 2 via the following formula

$$( ϕ = atan 2 ( \frac{{ρ}_{3} - {ρ}_{1}}{{ρ}_{0} - {ρ}_{2}} ) ) ,$$

and hence, the AoD from the base station since ϕ is also related to the AoD (i.e., θ_{AoD} from the boresight direction of the panel, where the boresight direction of a panel refers to the direction perpendicular to that panel) via the following formula

$$( ϕ = \frac{2 π W}{λ} sin {θ}_{A o D} )$$

where W is the distance between the centers of panels 1 and 2. During the RACH procedure, the UE sends MSG1, which includes the preamble from a specific group that indicates whether the values of ρ−ρ1 and ρ0−ρ2 are positive, negative, or zero. Such grouping may help the base station coarsely estimate the AoD. Then, in MSG3, the UE sends the actual measurements to help the base station finely estimate the AoD.

Some embodiments disclosed herein may provide methods for signaling that may be used for the proposed SSB patterns for IA and RACH processes. Embodiments disclosed herein may also provide methods for signaling that might be used for other reference signal (RS) transmissions for non-IA (NIA) such as CSI-RS in DL, S-RS in UL and SL.

In embodiments pertaining to IA, methods may include transmission of one or more of: auxiliary sequences and configuration information for configuring the auxiliary sequences such as an indication that auxiliary sequences are being transmitted by the base station for use by the UE, location information in a time and frequency resource, identification of complementary frequencies on which the auxiliary sequences are transmitted on. The auxiliary sequences and the configuration information, may be standardized or transmitted in PBCH payload such as SIB or MIB, or both.

The base station or network may inform the UE about the transmission of auxiliary sequences. In some embodiments, the UE selects the same UE receive beams to receive PSS or SSS of the SSB, or both, and XSSs to perform comparison of signal strengths. In some embodiments, the UE may consider the impact of different path-loss when receiving PSS or SSS of the SSB, or both, and XSSs that are sent on different frequencies.

In embodiments pertaining to non-IA, methods may include transmission of one or more of RS and RS configuration information (like CSI-RS pairing with auxiliary sequences (or auxiliary RS) to the UE via higher layer signaling. Examples of RS configuration information may include an identification of frequency and time resources for the RS and auxiliary sequences.

Beam tracking reference signals (BTRSs) may be considered as reference signals with multiple tilted beams in azimuth or elevation directions, or both, that, when configured, may be useful to track UE movement.

In embodiments pertaining to a RACH process, methods may include grouping of different RACH occasions or preambles in a preamble set, or both, into multiple sub-groups, which may be helpful for beam width refinement. In some embodiments, the preamble grouping or RACH occasions may be standardized and may be informed to the UE via higher layer signaling.

In some embodiments, the UE preamble selection and transmission to the network, for example in MSG 1, may implicitly indicate a relation between measured signal strength of PSS or SSS, or both, of the SSB, and XSS for coarse beam refinement.

In some embodiments, the UE transmission to the network, for example MSG3 or later type of signaling, may include the measurements made by the UE of signal strength for PSS or SSS, or both, of the SSB, XSS that may be used at the base station for fine beam refinement.

In some embodiments, when a RACH process is implemented in a two-step RACH procedure, as opposed to a four step RACH process shown in FIG. 8, the UE may send information included in both MSG1 and MSG3 of the 4-step RACH procedure in a single message, which may be referred to as MSG A.

In some embodiments, SSB may be combined with CSI-RS. For example, SSB #29 (of the 64 SSBs for a cardinality of 64) may be transmitted on a beam that has a similar direction as a CSI-RS. In such scenario, the network or base station informs the UE about the CSI-RS and SSB that have overlapped beams. The SSB and CSI-RS may be sent on the same or different time. The SNR relation between the overlapped SSB and CSI-RS signals may help the base station determine a better directionality for communications in a manner similar to FIGS. 7 and 8.

While some embodiments described herein show how to utilize fast beam acquisition with the proposed SSB patterns and RACH procedure, it should be noted that existing and NR standard accepted SSB patterns can be found in NR-Release 17 (R17) for FR2-2 range (approximately between 52.6-71 GHz).

It may be possible that existing SSB patterns, such as that shown in FIG. 4, could be used to transmit SSB #k+1 414 via a tilted beam direction as compared to that of SSB #k 412 so that the received signal strengths of PSS or SSS in SSB #k and SSB #k+1 may be used to acquire a narrow beam in a same raster frequency as the SSB.

In addition, non-CD-SSB may provide an option to send an SSB in a different frequency than the raster frequency. Hence, it may be used to perform similar measurements with existing patterns in NR R17 to that of embodiments described herein where one or more auxiliary sequences are transmitted in a different raster frequency as the SSB. However, using the existing SSB patterns may have drawbacks, and lack particular benefits, as compared to embodiments described herein.

With regard to adjacent beam locations, the UE may need to report all SSBs received with sufficient strengths, i.e. that achieve or exceed a certain threshold, and there is no suggestion or disclosure of preamble grouping as presented herein, such as that shown in the example of FIG. 7.

Trying to use existing SSB patterns to perform beam acquisition by making the wide beams of SSB blocks overlap may cause the total coverage of the wide beams with SSB blocks to be reduced, and therefore more SSB blocks may be needed. This would have the effect of reducing the bandwidth efficiency as compared to methods described herein. Furthermore, in the overlapped beams, the PBCH payload is repeated, further reducing bandwidth efficiency.

In some embodiments of the present disclosure, the SSB patterns may have advantages over existing SSB patterns, such as faster beam acquisition and improved controllability.

There are multiple reasons why embodiments of the present disclosure may have faster beam acquisition. For the same SSB cardinality (number of SSB blocks in SSB burst), a more accurate beam may be obtained as each SSB block includes one or more auxiliary sequences that may be sent on the same beam or on a different beam. A faster RACH process may result due to the information implicitly included via preamble selection for coarse beam refinement and lower overhead feedback from a UE to a base station as the UE may only send information of the signal strengths of PSS, SSS and auxiliary sequences in an SSB block to facilitate beam width refinement. Better utilization of the wide bandwidth at sub-THz band may result as the auxiliary sequences may be sent on different frequencies than the raster frequency without the need to resend the PBCH payload.

There are multiple reasons why embodiments of the present disclosure may have improved controllability. In some embodiments, for an SSB limited cardinality number (i.e. 64), accuracy and reliability of measurements may be controlled by adjusting the tilted beams. The UE may be aware of overlapped beams as they are sent on the same SSB block, e.g. SSB and XSSs are sent on the same block. However, when sending SSBs at different times via overlapped beams, the UE may not know which SSBs are sent with overlapped beams. For example, consider that SSB #1 and SSB #2 are sent via overlapped beams, while SSB #3 is sent in another direction (i.e. the SSB #3 beam is not overlapped with SSB #1 or SSB #2). Then, if the UE measures the SNR of the three SSBs and finds that all of them are received with good SNR (i.e. satisfies certain threshold), the UE may not know which SSBs are sent with overlapped beams. Hence, the UE may not be able to select the preamble for a subset for MSG1 in RACH procedure.

In some embodiments, methods described herein may be useful for an amplitude radar method or for use with an interferometer consisting of multiple antenna panels.

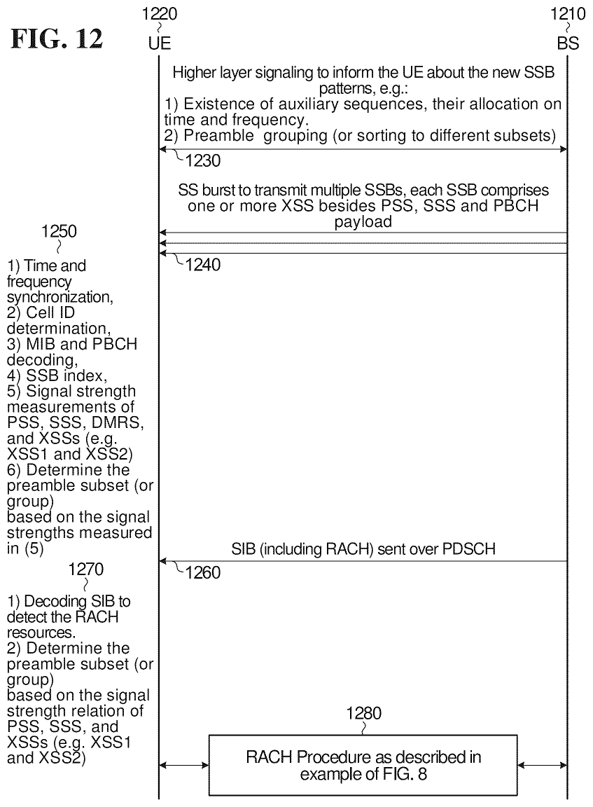

FIG. 12 illustrates an example of a multi-step transmission between a base station (BS) 1210 and a UE 1220 in which embodiments of the present disclosure may be used. At step 1230, the base station 1210 informs the UE 1220 about the SSB patterns, for example an indication of use by the base station 1210 of auxiliary sequences and time and frequency resource information pertaining to the auxiliary sequences. The base station 1210 may also provide the UE 1220 with information about how potential preambles are grouped to provide associations between measured PSS or SSS, or both, of the SSB and auxiliary signals. At step 1240, the base station 1210 transmits a synchronizing signal (SS) burst for which each SSB of the SS burst includes one or more auxiliary sequence in addition to the PSS, SSS and PBCH payload. The one or more auxiliary sequence may be transmitted on a different, but overlapped beam with that of the one or more SSBs.

At step 1250, the UE 1220 performs one or more of the following functions based on the received SSB burst: time and frequency synchronization, Cell ID determination, MIB and PBCH decoding, SSB index, signal strength measurements of some or all or PSS, SSS, DMRS, and XSSs (e.g. XSS1 and XSS2); and determination a preamble from an appropriate preamble subset (or group) based on measured signal strengths of some or all or PSS, SSS, DMRS, and XSSs. At step 1260, the base station 1210 sends SIB over the physical downlink shared channel (PDSCH).

At step 1270, the UE 1220 performs one or both of the following functions: decoding SIB to detect the RACH resources or determine the preamble subset (or group) based on the signal strength relation of PSS or SSS, or both of the SSB, and XSSs (e.g. XSS1 and XSS2). At step 1280, a RACH procedure may be performed in a manner as described in the example of FIG. 8 that uses information that has been determined between 1230 and 1270 in FIG. 12.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method for beam acquisition comprising:
receiving, by a user equipment (UE), one or more synchronization signal blocks (SSBs) and at least one auxiliary sequence, wherein the at least one auxiliary sequence is transmitted on a first beam, the first beam being different from but overlapping with a second beam of the one or more SSBs; and
transmitting, by the UE, feedback based on measurement of the one or more SSBs and the at least one auxiliary sequence.

2. The method of claim 1, wherein the at least one auxiliary sequence is received on a same frequency as the one or more SSBs.

3. The method of claim 2, wherein the at least one auxiliary sequence is received on different orthogonal frequency division multiplexed (OFDM) symbols.

4. The method of claim 3, wherein the different OFDM symbols are spaced apart by at least one OFDM symbol.

5. The method of claim 1, wherein the at least one auxiliary sequence is received on a different frequency than a frequency on which the one or more SSBs are received.

6. A device comprising:
at least one processor; and
a computer-readable storage medium, having stored thereon, computer executable instructions, that when executed by the at least one processor, cause the device to:
receive one or more synchronization signal blocks (SSBs) and at least one auxiliary sequence, wherein the at least one auxiliary sequence is transmitted on a different but overlapped beam with a beam of the one or more SSBs; and
transmit feedback based on measurement of the one or more SSBs and the at least one auxiliary sequence.

7. The device of claim 6, wherein the at least one auxiliary sequence is received on a same frequency as the one or more SSBs.

8. The device of claim 7, wherein the at least one auxiliary sequence is received on different orthogonal frequency division multiplexed (OFDM) symbols.

9. The device of claim 8, wherein the different OFDM symbols are spaced apart by at least one OFDM symbol.

10. The device of claim 6, wherein the at least one auxiliary sequence is received on a different frequency than a frequency on which the one or more SSBs are received.

11. A method for beam acquisition comprising:
transmitting, by a base station, one or more synchronization signal blocks (SSBs) and at least one auxiliary sequence, wherein the at least one auxiliary sequence is transmitted on a first beam, the first beam being different from but overlapping with a second beam of the one or more SSBs; and
receiving, by the base station, feedback based on measurement of the one or more SSBs and the at least one auxiliary sequence.

12. The method of claim 11, wherein the at least one auxiliary sequence is transmitted on a same frequency as the one or more SSBs.

13. The method of claim 12, wherein the at least one auxiliary sequence is transmitted on different orthogonal frequency division multiplexed (OFDM) symbols.

14. The method of claim 13, wherein the different OFDM symbols are spaced apart by at least one OFDM symbol.

15. The method of claim 12, wherein the one or more SSBs and the at least one auxiliary sequence are transmitted by a same radio frequency (RF) chain.

16. A device comprising:
at least one processor; and
a computer-readable storage medium, having stored thereon, computer executable instructions, that when executed by the at least one processor, cause the device to:
transmit one or more synchronization signal blocks (SSBs) and at least one auxiliary sequence, wherein the at least one auxiliary sequence is transmitted on a first beam, the first beam being different from but overlapping with a second beam of the one or more SSBs; and
receive feedback based on measurement of the one or more SSBs and the at least one auxiliary sequence.

17. The device of claim 16, wherein the at least one auxiliary sequence is transmitted on a same frequency as the one or more SSBs.

18. The device of claim 17, wherein the at least one auxiliary sequence is transmitted on different orthogonal frequency division multiplexed (OFDM) symbols.

19. The device of claim 18, wherein the different OFDM symbols are spaced apart by at least one OFDM symbol.

20. The device of claim 17, wherein the one or more SSBs and the at least one auxiliary sequence are transmitted by a same radio frequency (RF) chain.
